(19) United States
(12) Patent Application Publication
(10) Pub. No.: US 2023/0059657 A1
(43) Pub. Date: Feb. 23, 2023

(54) MULTI-CAMERA ZOOM CONTROL METHOD AND APPARATUS, AND ELECTRONIC SYSTEM AND STORAGE MEDIUM

(71) Applicant: MEGVII (BEIJING) TECHNOLOGY CO., LTD., Haidian District, Beijing (CN)

(72) Inventor: Gang HU, Haidian District, Beijing (CN)

(21) Appl. No.: 17/792,332

(22) PCT Filed: Sep. 30, 2020
(86) PCT No.: PCT/CN2020/119476

§ 371 Date: Jul. 12, 2022

(30) Foreign Application Priority Data
Apr. 14, 2020 (CN) 202010292168.X

(51) Int. Cl. H04N 5/232; H04N 5/265; H04N 5/262; H04N 13/239; H04N 13/246; G06T 3/00

(52) U.S. Cl. CPC H04N 5/23296; H04N 5/23216; H04N 5/265; H04N 5/232127; H04N 5/2628; H04N 13/239; H04N 13/246; G06T 3/0006; H04N 5/23218

(57) ABSTRACT

A multi-camera zoom control method and apparatus, and an electronic system and a storage medium. The method includes: in the process of a first camera collecting an image, if the current set magnification input by a user is in a magnification transition zone, starting a second camera; acquiring a corresponding stereo correction matrix on the basis of calibration parameters of the first camera and the second camera; calculating a translation matrix on the basis of an acquired pixel position corresponding relationship between the same content regions of interest that correspond to a first zoomed image and a second zoomed image and in combination with the current set magnification, and then calculating a smooth transition transformation matrix in combination with the stereo correction matrix; and performing, by applying the smooth transition transformation matrix, affine transformation on an image output by the first camera, to obtain a display image of a device.

### CROSS-REFERENCE TO THE RELATED APPLICATIONS

The present disclosure claims the priority of the Chinese patent application filed on Apr. 14, 2020 with the application number of 202010292168X and the title of “MULTI-CAMERA ZOOM CONTROL METHOD AND APPARATUS, AND ELECTRONIC SYSTEM AND STORAGE MEDIUM”, and the Chinese patent application is incorporated herein in its entirety by reference.

### TECHNICAL FIELD

The present application relates to the technical field of image processing, and more particularly, to a multi-camera zoom control method and apparatus, an electronic system and a storage medium.

### BACKGROUND

Digital cameras usually achieve optical zoom by the structure of the optical lens. The optical zoom is generated by the position change of a lens, an object, and a focus point. When an imaging plane moves in a horizontal direction, an angle of view and a focal length are changed, a farther scenery is clearer, and there is a progressive perception of objects visually.

In the field of mobile terminal (e.g., mobile phone) photography, since the thickness of a single lens is insufficient, a zoom mode of the aforementioned optical lens cannot be realized, and thus double-camera and multi-camera modules are selected for optical zoom. For example, in the double-camera zoom, a camera module with a field of vision (FOV) combined by about 80-degree Wide+40-degree Tele is generally selected, i.e., adopting a Wide lens and a Tele lens. Under this module, if magnification is 1×-2×, the digital magnification is realized by using the Wide lens. When the magnification is 2×, the Wide lens is switched to the Tele lens. When the magnification is greater than 2×, the digital magnification is realized by using the Tele lens.

The lens switching between the double-camera and multi-camera modules is generally referred to as 2× switching, i.e., double-camera zoom switching. Due to the problems in the manufacturing process of the lenses and the modules, the 2× switching tends to cause a large jump in image content, i.e., a large translation in the same content region. Based on the content jump problem caused by the 2× switching, the following means are provided in the existing modes to alleviate the problem.

(1) A direct switching method, in the process of module production, the accuracy of optical axis management and control is increased. As the accuracy of optical axis management and control is higher, the problem of the content jump is smaller. No processing is performed in the process of 2× switching. In this mode, the difficulty of module production is increased, the accuracy is difficult to ensure, and the problem of content jump cannot be effectively solved.

(2) Stereo correction alignment is performed on an image based on calibration parameters of each lens. In this mode, vertical alignment of baselines and alignment at a known distance may be realized. However, once the modules are collided or aged, the relationship between the modules will be changed to cause a jump. In addition, when it is difficult to know a stable distance, it is still difficult to align in an automatic focus (AF) mode.

(3) Feature points are selected from the image, and the alignment is detected by using the feature points. Since the stability of the feature points is poor and an effective detection region is uncontrollable, i.e., the feature points are not necessarily extracted from a region of interest, this mode also cannot effectively solve the problem of content jump.

At present, there is no effective solution to the problem of image instability during the lens alignment.

### SUMMARY

An object of the present application is to provide a multi-camera zoom control method and apparatus, and an electronic system, which may effectively improve the stability of image alignment during lens switching between multi-camera modules.

In a first aspect, an example of the present application provides a multi-camera zoom control method. The method is applied to a device configured with a first camera and a second camera. The device is pre-configured with a magnification transition zone. The method includes: starting, in the process of the first camera collecting an image, the second camera if a current set magnification input by a user is in the magnification transition zone; acquiring a stereo correction matrix under the current set magnification on the basis of calibration parameters of the first camera and the second camera; acquiring a first scaled image corresponding to the first camera and a second scaled image corresponding to a second camera; calculating a translation matrix on the basis of a pixel position corresponding relationship between the same content regions of interest that correspond to the first scaled image and the second scaled image and the current set magnification; calculating a smooth transition transformation matrix corresponding to the magnification transition zone according to the stereo correction matrix and the translation matrix; and warping an image output by the first camera by applying the smooth transition transformation matrix, so as to obtain a display image of the device.

Further, the magnification transition zone is a corresponding magnification interval between a preset first critical magnification and a preset second critical magnification, and the second critical magnification is a corresponding magnification when the display image of the device is switched from an image collected by the first camera to an image collected by the second camera.

Further, the step of acquiring a first scaled image corresponding to the first camera and a second scaled image corresponding to a second camera includes: centrally cutting and magnifying a first original image collected by the first camera and a second original image collected by the second camera, so as to obtain a first scaled image and a second scaled image.

Further, the first scaled image and the second scaled image have the same resolution. The step of calculating a translation matrix on the basis of a pixel position corresponding relationship between the same content regions of interest that correspond to the first scaled image and the second scaled image and the current set magnification includes: determining a total translation quantity corresponding to the magnification transition zone on the basis of a pixel position corresponding relationship between the same content regions of interest that correspond to the first scaled image and the second scaled image; and calculating a translation matrix according to the current set magnification and the total translation quantity.

Further, the resolution corresponding to the first scaled image and the second scaled image is a resolution corresponding to the second critical magnification.

Further, the step of determining a total translation quantity corresponding to the magnification transition zone on the basis of a pixel position corresponding relationship between the same content regions of interest that correspond to the first scaled image and the second scaled image includes: determining a focus point of the first scaled image; determining a first region of interest of the first scaled image and a second region of interest of the second scaled image by taking the focus point as a center; performing feature detection on the first region of interest and the second region of interest, so as to obtain first feature information corresponding to the first region of interest and second feature information corresponding to the second region of interest; determining a translation quantity of the first scaled image aligned to the second scaled image under the current set magnification on the basis of a pixel position corresponding relationship corresponding to the same feature information in the first feature information and the second feature information; and determining a total translation quantity corresponding to the magnification transition zone according to the translation quantity.

Further, the determining a focus point of the first scaled image includes: detecting whether a target object is contained in the first scaled image; if yes, taking the center of the target object as a focus point; and if no, taking the center of the first scaled image as a focus point.

Further, the determining a focus point of the first scaled image includes: if a display screen of the device is a touch screen, monitoring a point touch operation of a user on the touch screen; and taking the monitored point touch operation position as a focus point of the first scaled image.

Further, a graph of the second region of interest has the same shape as that of a graph of the first region of interest, and the graph of the second region of interest is larger than the graph of the first region of interest.

Further, the step of determining a total translation quantity corresponding to the magnification transition zone according to the translation quantity includes: setting a total translation quantity T=(×1+(×2−wideScale))*t corresponding to the magnification transition zone, wherein ×1 is a magnification corresponding to a first FOV, ×2 is a magnification corresponding to a second FOV, wideScale is an actual magnification corresponding to the first camera under the current set magnification, and t is a translation quantity of the first scaled image aligned to the second scaled image under the current set magnification.

Further, the step of acquiring a stereo correction matrix under the current set magnification on the basis of calibration parameters of the first camera and the second camera includes: setting a stereo correction matrix under the current set magnification as H_{w1}=Hₛ₂*H_{wt}*Hₛ₁, wherein H_{wt}=Kₜ*R_{tw}⁻¹*K_{w}⁻¹; H_{wt} represents a stereo correction matrix aligning a first original image to a second original image; Kₜ is a calibration internal parameter of the second camera; K_{w} is a calibration internal parameter of the first camera; R_{tw} is a pre-calibrated rotation matrix from the first camera to the second camera;

Hₛ₁ represents a magnification matrix converting the first scaled image to the first original image; and Hₛ₂ represents a magnification matrix converting the second original image to the second scaled image.

Further, the step of calculating a translation matrix according to the current set magnification and the total translation quantity includes: setting a translation matrix Hₜ as follows:

$${H}_{t} = [ \begin{matrix}1 & 0 & \frac{wideScale - first critical magnification}{\begin{matrix}second critical magnification - \\ first critical magnification\end{matrix}} ⋆ {T}_{x} - {T}_{0 x} \\ 0 & 1 & \frac{wideScale - first critical magnification}{\begin{matrix}second critical magnification - \\ first critical magnification\end{matrix}} ⋆ {T}_{y} - {T}_{0 y} \\ 0 & 0 & 1\end{matrix} ]$$

T₀ₓ is a quantity of translation completed from a first critical magnification to a current display magnification in an x-direction, and T_{0y} is a quantity of translation completed from the first critical magnification to the current display magnification in a y-direction; Tₓ is a total translation quantity from the current display magnification to a second critical magnification in the x-direction; and T_{y} is a total translation quantity from the current display magnification to the second critical magnification in the y-direction.

Further, the step of calculating a smooth transition transformation matrix corresponding to the magnification transition zone according to the stereo correction matrix and the translation matrix includes:

setting a smooth transition transformation matrix as H=Hₜ*Hₛ₃*H_{wt}*Hₛ₁, wherein Hₜ is the translation matrix;

$${H}_{s 3} = {H}_{s 1}^{- 1} ⋆ [ \begin{matrix}fw / ft & 0 & 0 \\ 0 & fw / ft & 0 \\ 0 & 0 & 1\end{matrix} ] ;$$

Hₛ₁⁻¹ is a magnification matrix converting the first original image to the first scaled image; fw and ft are focal lengths of the first camera and the second camera respectively under the same resolution; H_{wt} represents a stereo correction matrix aligning the first original image to the second original image; and Hₛ₁ represents a magnification matrix converting the first scaled image to the first original image.

In a second aspect, an example of the present application provides a multi-camera zoom control apparatus provided on a device configured with a first camera and a second camera. The device is pre-configured with a magnification transition zone. The apparatus includes: a starting module, configured for start, in the process of the first camera collecting an image, the second camera if a current set magnification input by a user is in the magnification transition zone; a first acquisition module, configured for acquire a stereo correction matrix under the current set magnification on the basis of calibration parameters of the first camera and the second camera; a second acquisition module, configured for acquire a first scaled image corresponding to the first camera and a second scaled image corresponding to a second camera; a first calculation module, configured for calculate a translation matrix on the basis of a pixel position corresponding relationship between the same content regions of interest that correspond to the first scaled image and the second scaled image and the current set magnification; a second calculation module, configured for calculate a smooth transition transformation matrix corresponding to the magnification transition zone according to the stereo correction matrix and the translation matrix; and a third acquisition module, configured for warp an image output by the first camera by applying the smooth transition transformation matrix, so as to obtain a display image of the device.

In a third aspect, an example of the present application provides an electronic system. The electronic system is a device configured with a first camera and a second camera. The electronic system includes an image input apparatus, a processor and a storage apparatus. The image input apparatus is configured for acquire image data collected by the first camera and second camera. The storage apparatus stores a computer program which, when executed by the processor, performs the multi-camera zoom control method in the first aspect.

In a fourth aspect, an example of the present application provides a computer-readable storage medium having a computer program stored thereon. The computer program, when executed by a processor, performs the steps of the multi-camera zoom control method in the first aspect.

According to the multi-camera zoom control method and apparatus, and the electronic system provided in the present application, in the process of a first camera collecting an image, if a current set magnification input by a user is in a magnification transition zone, a second camera is started. A stereo correction matrix under the current set magnification is acquired on the basis of calibration parameters of the first camera and the second camera. A translation matrix is calculated on the basis of an acquired pixel position corresponding relationship between the same content regions of interest that correspond to a first scaled image and a second scaled image and in combination with the current set magnification. A smooth transition transformation matrix corresponding to the magnification transition zone is calculated according to the stereo correction matrix and the translation matrix. An image output by the first camera is warped by applying the smooth transition transformation matrix, so as to obtain a display image of a device. According to the method, a stable translation quantity is obtained in a region of interest on the basis of stereo correction alignment of an image by using a template matching mode (determining a region of interest in a first scaled image, taking the region of interest as a template, and determining a target region corresponding to the template in a second scaled image, a pixel position corresponding relationship between the region of interest and the target region being a pixel position corresponding relationship between the same content regions of interest corresponding to the first scaled image and the second scaled image), so as to realize the smooth transition of the region of interest, thereby improving the alignment stability of the region of interest.

Other features and advantages of the present application will be set forth in the following description, or some features and advantages may be inferred or unambiguously determined from the description, or may be learned by practicing the aforementioned technology of the present application.

In order to make the aforementioned objects, features and advantages of the present application more apparent and understandable, preferred examples of the present application are provided below for the following detailed description in conjunction with the accompanying drawings.

### BRIEF DESCRIPTION OF THE DRAWINGS

In order to more clearly illustrate the technical solutions of specific embodiments of the present application or in the related art, the figures that are required to describe the specific embodiments or the related art will be briefly introduced below. Apparently, the figures that are described below are merely some embodiments of the present application, and a person skilled in the art may obtain other figures according to these figures without paying creative work.

FIG. 1 shows a schematic structural diagram of an electronic system provided by an embodiment of the present application;

FIG. 2 shows a flowchart of a multi-camera zoom control method provided by an embodiment of the present application;

FIG. 3 shows a flowchart of another multi-camera zoom control method provided by an embodiment of the present application;

FIG. 4 shows a flowchart of another multi-camera zoom control method provided by an embodiment of the present application;

FIG. 5(a) and FIG. 5(b) show flowcharts of another multi-camera zoom control method provided by an embodiment of the present application; and

FIG. 6 shows a schematic structural diagram of a multi-camera zoom control apparatus provided by an embodiment of the present application.

### DETAILED DESCRIPTION OF THE EMBODIMENTS

In order to make the objects, technical solutions and advantages of examples of the present application more apparent, the technical solutions of the present application will be clearly and completely described below with reference to the drawings. Apparently, the described examples are merely certain examples of the present application, rather than all of the examples. All of the other examples obtained by a person ordinarily skilled in the art on the basis of the examples of the present application without paying creative work fall within the protection scope of the present application.

Aiming at the problem of poor alignment stability of a region of interest during lens switching between double-camera and multi-camera modules, embodiments of the present application provide a multi-camera zoom control method and apparatus, and an electronic system and a storage medium. This technology may be applied to image display control of various medium and high-end mobile phone types and devices with double-camera or multi-camera modules. Since two adjacent cameras with magnifications in the multi-camera module may also be regarded as a double-camera combination structure, this technology may also be applied to a scene of smooth camera switching of double-camera, triple-camera, and multi-camera devices. The specific description is shown by the following embodiments.

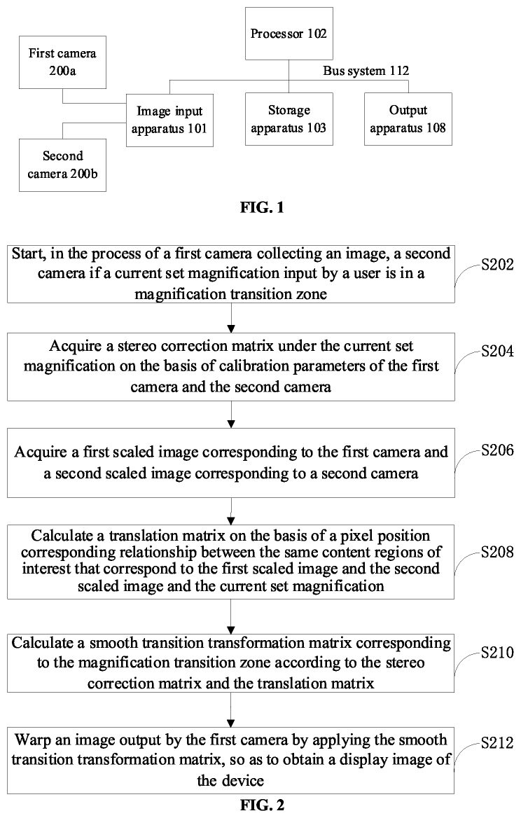

Referring to FIG. 1, the embodiment of the present application provides an electronic system. The electronic system is a device configured with a first camera 200a and a second camera 200b.

The electronic system includes an image input apparatus 101, a processor 102 and a storage apparatus 103.

The image input apparatus 101 is configured for acquiring image data collected by the first camera 200a and the second camera 200b. The image data includes a first original image collected by the first camera 200a and a second original image collected by the second camera 200b.

The storage apparatus 103 stores a computer program which, when executed by the processor 102, performs a multi-camera zoom control method described below (The specific content may refer to the following explanation).

In some alternative examples, there may be one or more first cameras 200a, second cameras 200b, processors 102, and storage apparatuses 103 according to practical requirements. In order to facilitate viewing of the process and effects, the aforementioned electronic system may also include an output apparatus 108. These components are interconnected via a bus system 112 and/or other forms of connecting mechanisms (not shown). It should be noted that the components and structure of the electronic system shown in FIG. 1 are merely exemplary and non-limiting and that the electronic system may have some components shown in FIG. 1 or other components and structures not shown in FIG. 1 according to practical demands.

The processor 102 may be a gateway, an intelligent terminal, or a device that includes a central processing unit (CPU) or other forms of processing units having data processing capabilities and/or instruction execution capabilities. The processor may process data for other components in the electronic system and may control other components in the electronic system to perform desired functions.

In some alternative examples, the storage apparatus 103 may include one or more computer program products. The computer program product may include various forms of computer-readable storage media, such as a volatile memory and/or a non-volatile memory. The volatile memory may, for example, include a random access memory (RAM) and/or a cache, etc. The non-volatile memory may, for example, include a read-only memory (ROM), a hard disk, a flash memory, etc. One or more computer program instructions may be stored on the computer-readable storage medium. The program instructions may be executed by the processor 102 to perform client functions (implemented by the processor) and/or other desired functions in the examples of the present application described below. Various applications and various data may also be stored in the computer-readable storage medium, such as various data used and/or generated by the applications.

In some alternative examples, the image input apparatus 101 may be a data transmission interface for connecting with the first camera 200a and the second camera 200b to store the image data collected by the first camera 200a and the second camera 200b in the storage apparatus 103 for use by other components. The image input apparatus 101 may also include an apparatus for inputting instructions, such as one or more of a keyboard, a mouse, a microphone, and a touch screen.

In some alternative examples, the output apparatus 108 may output various information (e.g., images or sounds) to the outside (e.g., a user) and may include one or more of a display screen, a loudspeaker, etc.

In some alternative examples, various components in the electronic system for implementing the multi-camera zoom control method and apparatus may be integrally provided or may be dispersedly provided according to the embodiments of the present application. For example, the processor 102, the storage apparatus 103, the image input apparatus 101, and the output apparatus 108 may be integrated, while the first camera 200a and the second camera 200b may be provided at designated positions where images may be collected. When various devices in the aforementioned electronic systems is integrally provided, the electronic system may be implemented as an intelligent terminal such as a camera, a smartphone, a tablet computer, a computer, or a vehicle-mounted terminal.

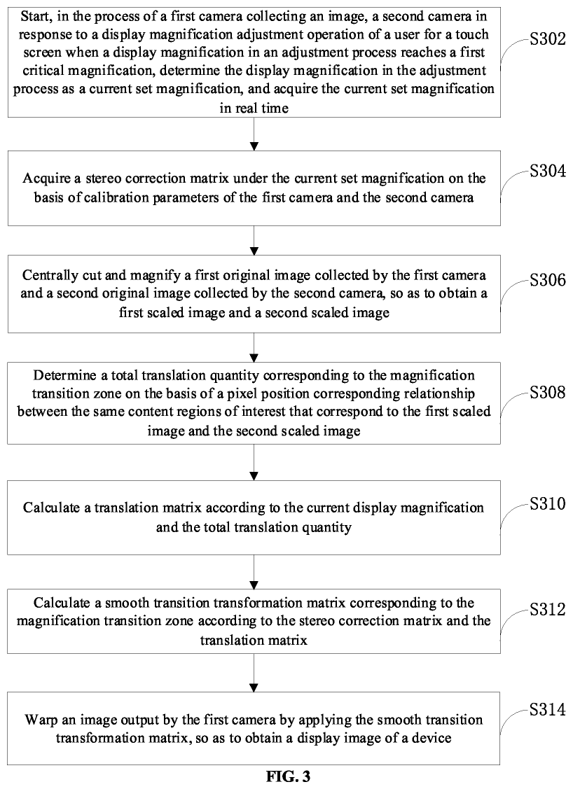

Referring to FIG. 2, the embodiment of the present application further provides a multi-camera zoom control method, which is applied to a device configured with a first camera and a second camera. A first FOV of the first camera may be greater than or less than a second FOV of the second camera.

For example, a mobile phone configured with a double-camera module is taken as an example. In double-camera zoom, a combination of Wide having an FOV of about 80 degrees and Tele having an FOV of about 40 degrees may be selected. Wide is the first camera having the first FOV of 80 degrees, and Tele is the second camera having the second FOV of 40 degrees. T<->W is generally marked on a manually adjustable lens. T is Tele, i.e., distant. A focal length of the lens may be increased by adjusting the lens in the direction of T, and a visible range (field of view) is reduced. Therefore, a specific object will be enlarged in the whole picture, and the details will be likely to distinguish. W is Wide, i.e., wide. The focal length of the lens may be reduced by adjusting the lens in the direction of W, and a visible range (field of view) is expanded. Therefore, a specific object will be reduced in the whole picture, and the details will be unlikely to distinguish. The process of adjusting the focal length to increase or decrease the field of view is referred to as ZOOM. The device is pre-configured with a magnification transition zone. In practical implementation, the magnification transition zone is usually a magnification interval determined by two different magnifications. The magnification transition zone may be set according to switching points and practical algorithm requirements. As shown in FIG. 2, the method includes the following steps:

In step S202, in the process of a first camera collecting an image, a second camera is started if a current set magnification input by a user is in a magnification transition zone.

In some alternative examples, the current set magnification input by the user may be represented by userLevel. When collecting an image, the first camera is usually used to collect the image. In the collection process, it may be determined whether userLevel input by the user is in a magnification transition zone, if userLevel belongs to the magnification transition zone, and the second camera is started. The first camera and the second camera are started within the magnification transition zone at the same time. For example, the set magnification transition zone is 1.6×-2×.

In step S204, a stereo correction matrix under the current set magnification is acquired on the basis of calibration parameters of the first camera and the second camera.

In some alternative examples, the aforementioned calibration parameters usually include internal parameters of the first camera and the second camera, a relative position between the first camera and the second camera, and other parameters such as three-dimensional translation t and rotation R parameters between the first camera and the second camera. The aforementioned stereo correction may be understood as correcting two images of an actual non-coplanar line alignment collected by the first camera and the second camera into a coplanar line alignment. That is, the two images are on the same plane, and when the same point is projected onto two image planes, the point should be on the same line of two-pixel coordinate systems. In practical implementation, a module composed of the first camera and the second camera is usually calibrated before leaving the factory, and calibration parameters are stored. A stereo correction matrix under the current set magnification may be acquired on the basis of these calibration parameters. Stereo correction may be performed on the first camera and the second camera via the stereo correction matrix.

In step S206, a first scaled image corresponding to the first camera and a second scaled image corresponding to a second camera are acquired.

In some alternative examples, the aforementioned first scaled image may be represented by wide1, and the second scaled image may be represented by tele1. The first scaled image and the second scaled image corresponding to the first camera and the second camera are acquired, respectively.

In step S208, a translation matrix is calculated on the basis of a pixel position corresponding relationship between the same content regions of interest that correspond to the first scaled image and the second scaled image and the current set magnification.

In some alternative examples, the aforementioned content region of interest may be understood as a region to be processed which is outlined in a box, a circle, an ellipse, an irregular polygon, etc. from a processed image in image processing. On the basis of the same content region of interest, a mathematical relationship between a pixel position of the content region of interest on the first scaled image and a pixel position on the second scaled image may be confirmed according to a corresponding relationship between the two-pixel positions and in combination with the current set magnification, and a translation matrix is calculated on the basis of the mathematical relationship.

In step S210, a smooth transition transformation matrix corresponding to the magnification transition zone is calculated according to the stereo correction matrix and the translation matrix.

In step S212, performing affine transformation to an image output by the first camera by applying the smooth transition transformation matrix, to obtain a display image of the device.

In some alternative examples, the aforementioned smooth transition transformation matrix may be used to realize a smooth transition between the first camera and the second camera, to avoid a large jump of image content when the first camera is switched to the second camera, i.e., a large translation in the same content region. In image processing, translation, scaling, rotation, and other operations may be performed on two-dimensional images by performing the affine transformation. In some alternative examples, by performing the affine transformation to the image output by the first camera through the smooth transition transformation matrix, a display image of the device may be output.

According to the multi-camera zoom control method provided in the embodiment of the present application, in the process of collecting an image by the first camera, if a current set magnification input by a user is in a magnification transition zone, the second camera is started. A stereo correction matrix under the current set magnification is acquired on the basis of calibration parameters of the first camera and the second camera. A translation matrix is calculated on the basis of an acquired pixel position corresponding relationship between the same content regions of interest that correspond to a first scaled image and a second scaled image and in combination with the current set magnification. A smooth transition transformation matrix corresponding to the magnification transition zone is calculated according to the stereo correction matrix and the translation matrix. Performing the affine transformation to an image output by the first camera by applying the smooth transition transformation matrix, to obtain a display image of a device. According to the method, a stable translation quantity is obtained in a region of interest on the basis of stereo correction alignment of an image by using a template matching mode (determining a region of interest in a first scaled image, taking the region of interest as a template, and determining a target region corresponding to the template in a second scaled image, a pixel position corresponding relationship between the region of interest and the target region being a pixel position corresponding relationship between the same content regions of interest corresponding to the first scaled image and the second scaled image), to realize the smooth transition of the region of interest, thereby improving the alignment stability of the region of interest.

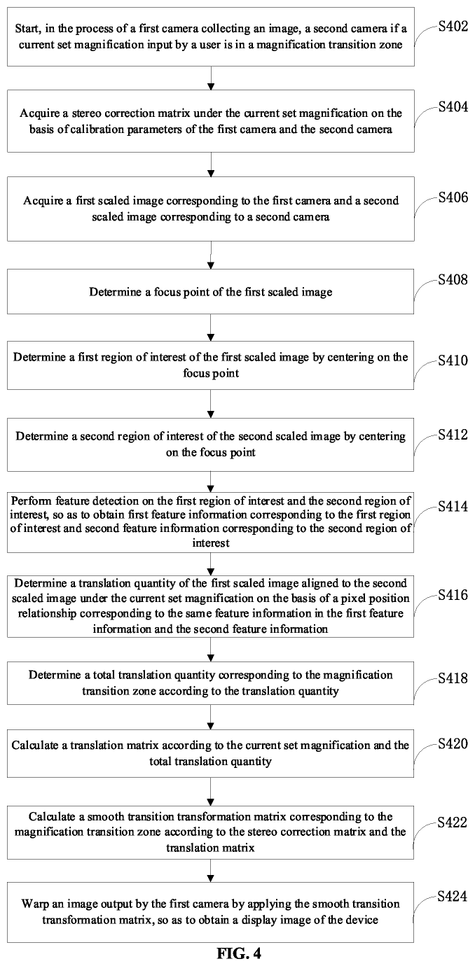

As referring to FIG. 3, the present embodiment provides another multi-camera zoom control method. The method is implemented on the basis of the aforementioned examples. The present embodiment focuses on describing a specific process of starting a second camera if a current set magnification input by a user is in a magnification transition zone, and a specific process of acquiring a first scaled image corresponding to a first camera and a second scaled image corresponding to the second camera and calculating a translation matrix on the basis of a pixel position corresponding relationship between the same content regions of interest that correspond to the first scaled image and the second scaled image and the current set magnification. In the present embodiment, a display screen of a device is a touch screen. The magnification transition zone is a corresponding magnification interval between a preset first critical magnification and a preset second critical magnification, and the second critical magnification is a corresponding magnification when a display image of the device is switched from an image collected by the first camera to an image collected by the second camera. For example, when the first critical magnification is 1.6× and the second critical magnification is 2×, the magnification transition zone is 1.6×-2×. If the second critical magnification is 2×, switching from the image collected by the first camera to the image collected by the second camera at 2× may also be understood as switching from an image of the first camera displayed on an interface to an image of the second camera at 2×. The image of the second camera will always be displayed at a magnification greater than 2×. The first scaled image and the second scaled image have the same resolution. The resolution corresponding to the first scaled image and the second scaled image is a resolution corresponding to the second critical magnification. The method includes the following steps:

In step S302, in the process of collecting an image by the first camera, the second camera is started in response to a display magnification adjustment operation of a user for a touch screen when a display magnification in an adjustment process reaches a first critical magnification, the display magnification in the adjustment process is determined as a current set magnification, and the current set magnification is acquired in real time.

In some alternative examples, a user may slide a touch screen to adjust a display magnification according to his demands. In the adjustment process, the display magnification is a real-time changing process. If the display magnification reaches a first critical magnification, it means that the display magnification in the adjustment process of the user enters a magnification transition zone. At this moment, a second camera is usually started at the same time, the display magnification in the adjustment process is determined as a current set magnification, and the current set magnification is acquired in real time.

In step S304, a stereo correction matrix under the current set magnification is acquired on the basis of calibration parameters of the first camera and the second camera.

In step S306, a first original image collected by the first camera and a second original image collected by the second camera are centrally cut and zoomed in, to obtain a first scaled image and a second scaled image.

In some alternative examples, at the beginning of optical zoom, a platform (i.e., a processor of the aforementioned device) calculates scaling coefficients of a first original image and a second original image according to an input userLevel of the user. Assuming that focal lengths of the first camera and the second camera under the same resolution are fw and ft, respectively, the scaling coefficient of the first original image is widescale=userLevel, and the scaling coefficient of the second original image is teleScale=fw/ft*wideScale. The platform may perform central cut and zoom in to the first original image to obtain the first scaled image according to the given widescale; and the platform may perform central cut and zoom in to the second original image to obtain the second scaled image tele1 according to the given teleScale. It should be noted that taking a mobile phone configured with a first camera and a second camera as an example, the aforementioned platform may be understood as a processor in the mobile phone. The first original image and the second original image may be an image stream including a plurality of images.

In step S308, a total translation quantity corresponding to the magnification transition zone is determined on the basis of a pixel position corresponding relationship between the same content regions of interest that correspond to the first scaled image and the second scaled image.

In some alternative examples, on the basis of the same content region of interest, a total translation quantity of an image corresponding to the magnification transition zone may be determined according to a corresponding relationship between a pixel position of the content region of interest on the first scaled image and a pixel position on the second scaled image.

In step S310, a translation matrix is calculated according to the current set magnification and the total translation quantity.

In some alternative examples, a mathematical relationship between the pixel position of the content region of interest on the first scaled image and the pixel position on the second scaled image may be confirmed according to the acquired current set magnification and the aforementioned total translation quantity, and a translation matrix is calculated on the basis of the mathematical relationship.

In step S312, a smooth transition transformation matrix corresponding to the magnification transition zone is calculated according to the stereo correction matrix and the translation matrix.

In step S314, performing the affine transformation to an image output by the first camera by applying the smooth transition transformation matrix, to obtain a display image of a device.

According to another multi-camera zoom control method provided in the embodiment of the present application, in the process of a first camera collecting an image, a second camera is started in response to a display magnification adjustment operation of a user for a touch screen when a display magnification in an adjustment process reaches a first critical magnification. The display magnification acquired in real time is taken as a current set magnification. A stereo correction matrix under the current set magnification is acquired on the basis of calibration parameters of the first camera and the second camera. A first original image collected by the first camera and a second original image collected by the second camera are centrally cut and zoomed in, to obtain a first scaled image and a second scaled image, thereby determining a total translation quantity corresponding to the magnification transition zone and calculating a translation matrix in combination with the current set magnification. A smooth transition transformation matrix corresponding to the magnification transition zone is calculated according to the stereo correction matrix and the translation matrix. Performing the affine transformation to an image output by the first camera by applying the smooth transition transformation matrix, to obtain a display image of a device. According to the method, a stable translation quantity is obtained in a region of interest by means of template matching on the basis of stereo correction alignment of an image, to realize the smooth transition of the region of interest, thereby improving the alignment stability of the region of interest.

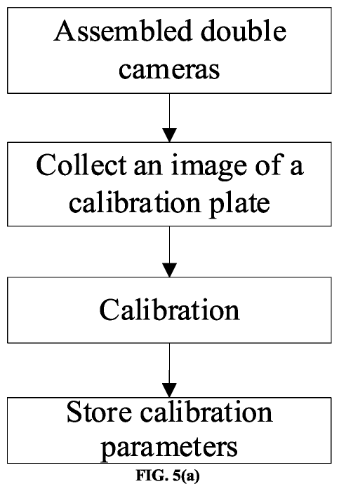

As referring to FIG. 4, the embodiment of the present application provides another multi-camera zoom control method. The method is implemented on the basis of the aforementioned examples. The present embodiment focuses on describing a specific process of determining a total translation quantity corresponding to a magnification transition zone on the basis of a pixel position corresponding relationship between the same content regions of interest corresponding to a first scaled image and a second scaled image. The method includes the following steps:

In step S402, in the process of collecting an image by a first camera, a second camera is started if a current set magnification input by a user is in a magnification transition zone.

In step S404, a stereo correction matrix under the current set magnification is acquired on the basis of calibration parameters of the first camera and the second camera.

In step S406, a first scaled image corresponding to the first camera and a second scaled image corresponding to a second camera are acquired.

In step S408, a focus point of the first scaled image is determined.

Optionally, step S408 may be implemented in at least the following two modes.

In the first mode, detecting whether a target object is contained in the first scaled image. If yes, the center of the target object is taken as a focus point. If no, the center of the first scaled image is taken as a focus point. For example, a first scaled image containing a human face is taken as an example. It may be detected whether the first scaled image contains a human face by taking the human face as a target object. If yes, the center of the human face may be taken as a focus point. If no, the center of the first scaled image may be taken as a focus point. A position corresponding to the focus point has the highest definition.

In the second mode, if a display screen of a device is a touch screen, a point touch operation of a user on the touch screen is monitored. The monitored point touch operation position is taken as a focus point of the first scaled image. In practical implementation, if the display screen of the device is a touch screen, the user may also select a position required as the focus point of the first scaled image according to actual requirements by clicking on the touch screen.

In step S410, a first region of interest of the first scaled image is determined by taking the focus point as a center. In practical implementation, step S410 may be implemented by the following first to third steps:

In the first step, edge detection is performed on a first sub-region covered by a preset graphic frame in the first scaled image by taking the focus point as the center of the preset graphic frame.

In some alternative examples, the aforementioned preset graphic frame may be understood as a matched graphic frame set according to a required size of the first region of interest. For example, a rectangular frame of 100pixel*100pixel may be selected, or, an appropriate graphic frame may also be selected according to demands. The coordinate of the focus point determined in any one of the aforementioned modes may be taken as the center of the preset graphic frame. In some alternative examples, an edge detection is performed on a first sub-region covered by the preset graphic frame in the first scaled image, and an edge of the first sub-region may be detected via a Sobel edge detection algorithm or other edge detection methods.

In the second step, if the length of the detected edge is greater than or equal to a preset length threshold, the first sub-region is taken as a first region of interest of the first scaled image.

In some alternative examples, the aforementioned preset length threshold may be determined on the basis of the size of the preset graphic frame. For example, if the size of the preset graphic frame is 100pixel*100pixel, the preset length threshold may be selected as 100pixel. If it is detected that the length of a gradient edge in the first sub-region is greater than or equal to 100pixel, the first sub-region may be taken as a first region of interest of the first scaled image. The first region of interest may be represented by W, i.e., a template image. The W image is warped as a W1 image according to the aforementioned stereo correction matrix, i.e., a W1 template image is obtained upon stereo correction of the W image.

In the third step, if the length of the detected edge is less than the preset length threshold, the preset graphic frame is gradually increased to perform edge detection until a second sub-region covered by the increased preset graphic frame has an edge greater than or equal to the preset length threshold, and the second sub-region is taken as a first region of interest of the first scaled image.

In some alternative examples, in order to facilitate understanding, the example where the size of the preset graphic frame is 100pixel*100pixel and the preset length threshold is 100pixel is still used to describe, if it is detected that the length of the gradient edge in the first sub-region is less than 100pixel, it is indicated that the detected edge length is small, or it may also be understood that the size of the preset graphic frame is small. At this moment, the size of the preset graphic frame needs to be increased gradually. In practical implementation, the size of the preset graphic frame may be increased gradually according to an increment to a long edge by 10 pixel at each time, and an appropriate increment at each time may also be selected according to demands. Edge detection is performed after each increase until a second sub-region covered by the increased preset graphic frame has an edge greater than or equal to the preset length threshold, and the second sub-region may be taken as a first region of interest of the first scaled image. The first region of interest may be represented by W, i.e., a template image. The W image is warped as a W1 image according to the aforementioned stereo correction matrix, i.e., a W1 template image is obtained upon stereo correction of the W image.

In step S412, a second region of interest of the second scaled image is determined by taking the focus point as a center.

In some alternative examples, a graph of the second region of interest usually has the same shape as that of a graph of the first region of interest, and the graph of the second region of interest is larger than the graph of the first region of interest. The second region of interest of the second scaled image is determined on the basis of the size of the first region of interest by taking the focus point as a center. For example, the coordinate of the focus point is selected on the second scaled image tele1 as the center, and 1.5 times the size of the first region of interest or other appropriate multiples greater than 1 is selected as a second region of interest of the second scaled image. The second region of interest may be represented by T, and may also be referred to as a matched image T. It should be noted that if the aforementioned multiple is selected to be too small, the content of the second region of interest would be too little, which is liable to make an error. If the multiple is selected to be too large, the performances of the first camera and the second camera are easily affected. Therefore, It is generally necessary to select an appropriate multiple according to an assembly error of the first camera and the second camera and a parallax size of a module.

In step S414, performing feature detection on the first region of interest and the second region of interest, to obtain first feature information corresponding to the first region of interest and second feature information corresponding to the second region of interest.

In some alternative examples, feature detection is performed on a first region of interest, extracting first feature points in the first region of interest to obtain corresponding first feature information, the quantity of the first feature points may be plural. For example, corner points in the first region of interest may be extracted. Performing feature detection on a second region of interest, extracting second feature points in the second region of interest to obtain corresponding second feature information, the quantity of the second feature points may be plural. For example, corner points in the second region of interest may be extracted.

In step S416, a translation quantity of the first scaled image aligned to the second scaled image under the current set magnification is determined on the basis of a pixel position corresponding relationship corresponding to the same feature information in the first feature information and the second feature information.

In some alternative examples, a normalized cross correlation (NCC) matching mode or other matching modes may be adopted to match pixel positions corresponding to the same feature information in the first feature information and the second feature information, and the position of the W1 template image on the matched image T is found. A translation quantity t of the first scaled image wide1 aligned to the second scaled image tele1 under the current set magnification is determined according to a pixel position corresponding relationship. Reference may be made to the existing template matching technology for details, and detailed descriptions are omitted herein.

In step S418, a total translation quantity corresponding to the magnification transition zone is determined according to the translation quantity.

Optionally, in some alternative examples, step S418 may include the following operations:

A total translation quantity T=(×1+(×2−wideScale))*t corresponding to the magnification transition zone is set, wherein ×1 is a magnification corresponding to a first field of vision (FOV), ×2 is a magnification corresponding to a second FOV, wideScale is an actual magnification corresponding to the first camera under the current set magnification, and t is a translation quantity of the first scaled image aligned to the second scaled image under the current set magnification.

For example, if ×1 is 1.0 and ×2 is 2.0, a total translation quantity T=0.0±(2.0−wideScale)*t corresponding to the magnification transition zone at 2× switching is obtained when the translation quantity of wide1 aligned to tele1 under the current set magnification is t.

In step S420, a translation matrix is calculated according to the current set magnification and the total translation quantity.

In step S422, a smooth transition transformation matrix corresponding to the magnification transition zone is calculated according to the stereo correction matrix and the translation matrix.

In step S424, performing affine transformation to an image output by the first camera by applying the smooth transition transformation matrix, to obtain a display image of the device.

Another multi-camera zoom control method provided by the embodiment of the present application focuses on describing a specific process of determining a total translation quantity corresponding to a magnification transition zone on the basis of a pixel position corresponding relationship between the same content regions of interest that correspond to a first scaled image and a second scaled image. After a focus point of the first scaled image is determined, a first region of interest of the first scaled image and a second region of interest of the second scaled image are respectively determined by taking the focus point as a center. Feature detection is performed on the first region of interest and the second region of interest, respectively, to obtain the first feature information corresponding to the first region of interest and the second feature information corresponding to the second region of interest. A translation quantity of the first scaled image aligned to the second scaled image under the current set magnification is determined on the basis of a pixel position corresponding relationship corresponding to the same feature information in the first feature information and the second feature information, thereby determining a total translation quantity corresponding to the magnification transition zone. According to the method, a stable translation quantity is obtained in a region of interest by means of template matching on the basis of stereo correction alignment of an image, to realize the smooth transition of the region of interest, thereby improving the alignment stability of the region of interest.

In addition, the influence of weak texture on template matching may be eliminated by gradient edge detection, thereby improving the robustness of the algorithm. At each zoom switching, a region of interest is usually determined on the basis of an edge detection technology, a translation quantity under a current set magnification is then calculated on the basis of the region of interest, and image fusion is performed on the basis of the translation quantity. Considering that a user holds a mobile phone while moving, therefore, the image content is also changing, and a translation quantity is generally calculated every preset time period. For example, the translation quantity may be calculated once every second or a set number of seconds, and a smooth transition is achieved by correcting the translation quantity.

On the basis of the aforementioned embodiments, the present embodiment provides another multi-camera zoom control method. The method is implemented on the basis of the aforementioned embodiments. The present embodiment focuses on describing a specific process of acquiring a stereo correction matrix under a current set magnification on the basis of calibration parameters of a first camera and a second camera, a specific process of calculating a translation matrix according to the current set magnification and a total translation quantity, and a specific process of calculating a smooth transition transformation matrix corresponding to a magnification transition zone according to the stereo correction matrix and the translation matrix. The method includes the following steps:

In step 502, in the process of collecting an image by a first camera, a second camera is started if a current set magnification input by a user is in a magnification transition zone.

In step 504, a stereo correction matrix under the current set magnification is set as H_{w1}=Hₛ₂*H_{wt}*Hₛ₁

The matrix is a stereo correction matrix of a first scaled image wide1 aligned to a second scaled image tele1 under the current set magnification, wherein H_{wt}=Kₜ*R_{tw}⁻¹*K_{w}⁻¹. H_{wt} represents a stereo correction matrix of a first original image (such as the aforementioned wide) to a second original image (such as the aforementioned tele). Kₜ is a calibration internal parameter of the second camera, i.e., a calibration internal parameter of a Tele lens. K_{w} is a calibration internal parameter of the first camera, i.e., a calibration internal parameter of a Wide lens. R_{tw} is a pre-calibrated rotation matrix from the first camera to the second camera, and is an external parameter in the calibration parameters, i.e., a rotation matrix from the Wide lens to the Tele lens. It should be noted that the calibration internal parameters are usually only related to an internal structure of the corresponding camera, and therefore these calibration internal parameters may also be referred to as internal parameters of the corresponding camera.

$${H}_{s {1}_{=}} [ \begin{matrix}1 / wideScale & 0 & 0 \\ 0 & 1 / wideScale & 0 \\ 0 & 0 & 1\end{matrix} ]$$

$${H}_{s {2}_{=}} [ \begin{matrix}teleScale & 0 & 0 \\ 0 & teleScale & 0 \\ 0 & 0 & 1\end{matrix} ]$$

Hₛ₁ represents a magnification matrix converting the first scaled image wide1 to the first original image. For example, the size of the first original image wide is 400*300. At this moment, the current set magnification input by the user is 1.5×. The platform zooms in 400*300 to 600*450 according to 1.5× input by the user, so as to obtain the first scaled image wide1. The image is input to the algorithm. Since all the calculations of the algorithm are based on the scale of an original image, the algorithm needs to know how the currently received first scaled image wide1 is restored to the first original image wide, which may be realized via Hₛ₁. Hₛ₂ represents a magnification matrix converting the second original image tele to the second scaled image tele1. wideScale is an actual magnification corresponding to the first camera under the current set magnification. teleScale is an actual magnification corresponding to the second camera under the current set magnification. An alignment matrix aligning the first scaled image wide1 to the second original image tele may also be obtained as H_{w0}=H_{wt}*Hₛ₁ according to H_{wt} and Hₛ₁.

In step 506, a first scaled image corresponding to the first camera and a second scaled image corresponding to a second camera are acquired.

In step 508, a total translation quantity corresponding to the magnification transition zone is determined on the basis of a pixel position corresponding relationship between the same content regions of interest that correspond to the first scaled image and the second scaled image.

In step 510, a translation matrix Hₜ is set as follows:

$${H}_{t} = [ \begin{matrix}1 & 0 & \frac{wideScale - first critical magnification}{\begin{matrix}second critical magnification - \\ first critical magnification\end{matrix}} ⋆ {T}_{x} - {T}_{0 x} \\ 0 & 1 & \frac{wideScale - first critical magnification}{\begin{matrix}second critical magnification - \\ first critical magnification\end{matrix}} ⋆ {T}_{y} - {T}_{0 y} \\ 0 & 0 & 1\end{matrix} ]$$

T₀ₓ is a quantity of translation completed from a first critical magnification to a current display magnification (i.e. a magnification corresponding to an image currently actually displayed in a device) in an x-direction, and T_{0y} is a quantity of translation completed from the first critical magnification to the current display magnification in a y-direction. Tₓ is a total translation quantity from the first critical magnification to a second critical magnification in the x-direction. T_{y} is a total translation quantity from the first critical magnification to the second critical magnification in the y-direction.

For ease of understanding, the example where the first critical magnification is 1.6× and the second critical magnification is 2.0× is still used to describe,

$${H}_{t} = [ \begin{matrix}1 & 0 & \frac{wideScale - 1.6}{0.4} ⋆ {T}_{x} - {T}_{0 x} \\ 0 & 1 & \frac{wideScale - 1.6}{0.4} ⋆ {T}_{y} - {T}_{0 y} \\ 0 & 0 & 1\end{matrix} ] .$$

If a translation quantity t is calculated at 1.6×, the image is translated by T₀(T₀ₓ, T_{0y})=t*(1.7×−1.6×)/(2.0×−1.6×) at 1.7×.

In step 512, a smooth transition transformation matrix is set as H=Hₜ*Hₛ₂*H_{wt}*Hₛ₁,

Hₜ is the translation matrix.

$${H}_{s 3} = {H}_{s 1}^{- 1} ⋆ [ \begin{matrix}fw / ft & 0 & 0 \\ 0 & fw / ft & 0 \\ 0 & 0 & 1\end{matrix} ] .$$

Hₛ₁⁻¹ is a magnification matrix converting the first original image wide to the first scaled image wide1. fw and ft are focal lengths of the first camera and the second camera respectively under the same resolution. H_{wt} represents a stereo correction matrix aligning the first original image wide to the second original image tele. Hₛ₁ represents a magnification matrix converting the first scaled image wide1 to the first original image wide.

In step 514, performing affine transformation to an image output by the first camera by applying the smooth transition transformation matrix, to obtain a display image of the device.

For example, performing the affine transformation to the first scaled image wide1 by applying the aforementioned smooth transition transformation matrix H, to obtain an output image out=H*wide1.

The embodiment of the present application provides another multi-camera zoom control method that focuses on describing a specific process of acquiring a stereo correction matrix under a current set magnification on the basis of calibration parameters of a first camera and a second camera, a specific process of calculating a translation matrix according to the current set magnification and a total translation quantity, and a specific process of calculating a smooth transition transformation matrix corresponding to a magnification transition zone according to the stereo correction matrix and the translation matrix. Specific expressions of the stereo correction matrix, the translation matrix and the smooth transition transformation matrix are respectively provided. According to the method, a stable translation quantity is obtained in a region of interest by means of template matching on the basis of stereo correction alignment of an image, to realize the smooth transition of the region of interest, thereby improving the alignment stability of the region of interest.

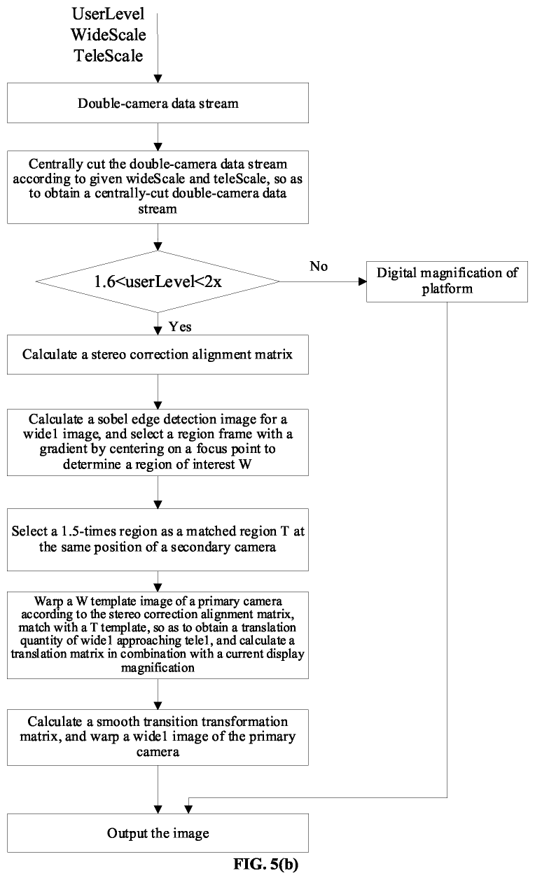

In order to further understand the aforementioned examples, a flowchart of another multi-camera zoom control method is provided below. As shown in FIGS. 5(a) and 5(b), a mobile phone configured with a first camera and a second camera is taken as an example.

As shown in FIG. 5(a), the work required to be completed before double cameras of the mobile phone leaves the factory includes: completing the assembly of double cameras on the mobile phone, opening image collection software, collecting an image of a calibration plate on the basis of the assembled double cameras, completing the calibration work, and finally verifying the calibration and storing calibration parameters into a fixed memory of the mobile phone.

As shown in FIG. 5(b), at the beginning of optical zoom, a platform will calculate scaling coefficients of Wide and Tele images according to userLevel input by a user (equivalent to the aforementioned current set magnification). Assuming that focal lengths under the same resolution of a primary camera and a secondary camera (equivalent to the aforementioned first camera and second camera) are respectively fw and ft, wideScale=userLevel, teleScale=fw/ft*wideScale. The platform centrally cuts a double-camera data stream (equivalent to an image stream) according to the given wideScale and teleScale, so as to obtain a first scaled image wide1 and/or a second scaled image tele1. It is determined whether the current set magnification falls within a preset magnification transition zone 1.6×-2×.

If no, the current set magnification and the first scaled image wide1 or the second scaled image tele1 are directly sent to the platform (if the current set magnification is less than 1.6×, the current set magnification corresponds to the first scaled image wide1, and if the current set magnification is greater than 2×, the current set magnification corresponds to the second scaled image tele1). After digital zoom in of the platform, an image is output, i.e., the platform will perform secondary zoom in. If the platform does not have this function, central zoom in may be realized via an algorithm. It may also be understood to perform image scaling processing according to the current set magnification.

If the current set magnification falls within a preset magnification transition zone 1.6×-2×, the double cameras are started at the same time. A stereo correction alignment matrix (equivalent to the aforementioned stereo correction matrix) under the current set magnification is calculated on the basis of calibration parameters of the first camera and the second camera. A sobe1 edge detection image is calculated for the wide1 image. A region frame with a gradient (equivalent to the aforementioned preset graphic frame) is selected by taking a focus point as the center to determine a region of interest W (equivalent to the aforementioned first region of interest, i.e. a W template image). If the length of a gradient edge in the region frame is less than a preset length threshold, the region frame is gradually increased to perform edge detection until the requirement is met. A 1.5-times region is selected as a matched region T (equivalent to the aforementioned second region of interest) at the same position of the secondary camera (equivalent to the aforementioned second camera). The W template image of the primary camera is warped according to the aforementioned stereo correction alignment matrix and matched with a T template, to obtain a translation quantity of wide1 approaching tele1. A translation matrix is calculated in combination with the current set magnification. A smooth transition transformation matrix corresponding to the magnification transition zone is calculated according to the stereo correction matrix and the translation matrix. The wide1 image of the primary camera is warped (equivalent to warping an image output by the first camera), and the transformed image is output and displayed.

According to the aforementioned multi-camera zoom control method, a module is calibrated before leaving the factory, calibration parameters are stored. A scaling coefficient of magnification transformation is calculated according to focal length information of primary and secondary cameras in the calibration parameters (i.e., when reaching a switching point, FOVs of the primary and secondary cameras are basically consistent), and digital zoom control of a lens is completed. Then, progressive stereo correction is performed under a section magnification before and after the first camera and the second camera are switched according to the calibration parameters. That is to say, correction to a certain extent is performed according to different magnifications and is just completed at the switching point. For example, if it is required to switch from the first camera to the second camera at 2×, a magnification is generally selected to be 1.6× to 2.3×. The first camera and the second camera are started at the same time within this magnification range. The double cameras are started before and after the switching, and only one camera is started at the remaining magnification, so that power consumption may be saved. The progressive stereo correction may be understood as assuming that the first camera and the second camera are subjected to stereo correction alignment at 2×, the first camera needs to rotate by 3°. In order to achieve smooth switching, 3° is generally distributed in the process of 1.6× to 2× according to a step size. The step size is equal to 3/(2.0−1.6)/10, indicating that each 0.1× needs to rotate by the step angle in the process of 1.6× to 2×. In this way, translation switching only in a parallax direction is basically achieved. It may also be understood that the first camera is aligned to the second camera after stereo correction at 2× switching. At this moment, corresponding features on images of the two cameras are on the same line, and only a horizontal parallax exists. Finally, a template image of an appropriate size is selected according to the position of a region of interest and an image gradient change, and matched with another lens to obtain a translation quantity. Finally, a smooth switching scheme of the region of interest may be realized according to the translation quantity.

For a multi-camera device, a combination mode of a three-camera module is, for example, usually Ultra+Wide+Tele, i.e., a large wide-angle lens of about 110 degrees+an ordinary lens of about 80 degrees+a telephoto lens of about 40 degrees. An implementation scheme is: displaying a wide image from 1.0× to 2.0×, displaying a tele image at >=2.0×, and displaying a large wide-angle image from 0.6× to 1.0×. 0.6×-2.0× may be regarded as a double-camera combination scheme of Ultra+Wide, and 1.0×-8× (10×) may be regarded as a double-camera scheme of Wide+Tele. A combination mode of a four-camera module is usually Ultra+Wide+Tele+periscopic telephoto lens. 2.0×-50× may be regarded as a double-camera scheme of Tele+periscopic telephoto lens. A switching magnification is generally 5.0×. The specific multi-camera zoom control method is as described above, and will not be described in detail herein by way of example.

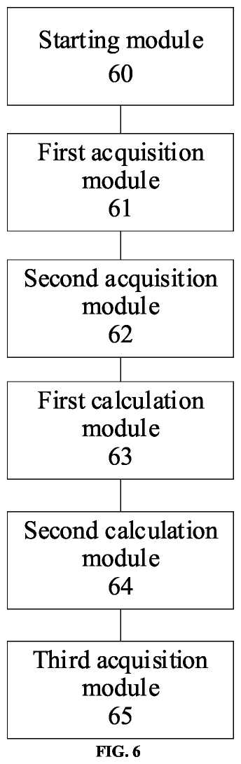

Corresponding to the aforementioned method examples, as referring in FIG. 6, an embodiment of the present application provides a schematic structural diagram of a multi-camera zoom control apparatus provided on a device configured with a first camera and a second camera. The device is pre-configured with a magnification transition zone.

The apparatus includes: a starting module 60, configured for starting, in the process of the first camera collecting an image, the second camera if a current set magnification input by a user is in the magnification transition zone; a first acquisition module 61, configured for acquiring a stereo correction matrix under the current set magnification on the basis of calibration parameters of the first camera and the second camera; a second acquisition module 62, configured for acquiring a first scaled image corresponding to the first camera and a second scaled image corresponding to a second camera; a first calculation module 63, configured for calculating a translation matrix on the basis of a pixel position corresponding relationship between the same content regions of interest that correspond to the first scaled image and the second scaled image and the current set magnification; a second calculation module 64, configured for calculating a smooth transition transformation matrix corresponding to the magnification transition zone according to the stereo correction matrix and the translation matrix; and a third acquisition module 65, configured for performing affine transformation to an image output by the first camera by applying the smooth transition transformation matrix, to obtain a display image of the device.

According to the multi-camera zoom control apparatus provided in the example of the present application, in the process of collecting an image by a first camera, if a current set magnification input by a user is in a magnification transition zone, a second camera is started. A stereo correction matrix under the current set magnification is acquired on the basis of calibration parameters of the first camera and the second camera. A translation matrix is calculated on the basis of an acquired pixel position corresponding relationship between the same content regions of interest that correspond to a first scaled image and a second scaled image and in combination with the current set magnification. A smooth transition transformation matrix corresponding to the magnification transition zone is calculated according to the stereo correction matrix and the translation matrix. An image output by the first camera is warped by applying the smooth transition transformation matrix, so as to obtain a display image of a device. According to the apparatus, a stable translation quantity is obtained in a region of interest by means of template matching on the basis of stereo correction alignment of an image, so as to realize the smooth transition of the region of interest, thereby improving the alignment stability of the region of interest.

Optionally, as a feasible implementation, the magnification transition zone is a corresponding magnification interval between a preset first critical magnification and a preset second critical magnification, and the second critical magnification is a corresponding magnification when the display image of the device is switched from an image collected by the first camera to an image collected by the second camera.

Optionally, as a feasible implementation, the second acquisition module 62 is also configured for central cutting and zooming in a first original image collected by the first camera and a second original image collected by the second camera, to obtain a first scaled image and a second scaled image.

Optionally, as a feasible implementation, the first scaled image and the second scaled image have the same resolution. The first calculation module 63 is also configured for determining a total translation quantity corresponding to the magnification transition zone on the basis of a pixel position corresponding relationship between the same content regions of interest that correspond to the first scaled image and the second scaled image; and calculating a translation matrix according to the current set magnification and the total translation quantity.

Optionally, as a feasible implementation, the resolution corresponding to the first scaled image and the second scaled image is a resolution corresponding to the second critical magnification.

Optionally, as a feasible implementation, the first calculation module 63 is also configured for determining a focus point of the first scaled image; determining a first region of interest of the first scaled image and a second region of interest of the second scaled image by taking the focus point as a center; performing feature detection on the first region of interest and the second region of interest, to obtain first feature information corresponding to the first region of interest and second feature information corresponding to the second region of interest; determine a translation quantity of the first scaled image aligned to the second scaled image under the current set magnification on the basis of a pixel position corresponding relationship corresponding to the same feature information in the first feature information and the second feature information; and determine a total translation quantity corresponding to the magnification transition zone according to the translation quantity.

Optionally, as a feasible implementation, the first calculation module 63 is also configured for detecting whether a target object is contained in the first scaled image; if yes, take the center of the target object as a focus point; and if no, take the center of the first scaled image as a focus point.

Optionally, as a feasible implementation, the first calculation module 63 is also configured for monitoring, if a display screen of the device is a touch screen, a point touch operation of a user on the touch screen; and take the monitored point touch operation position as a focus point of the first scaled image.

Optionally, as a feasible implementation, a graph of the second region of interest has the same shape as that of a graph of the first region of interest, and the graph of the second region of interest is larger than the graph of the first region of interest.

Optionally, as a feasible implementation, the first calculation module 63 is also configured for setting a total translation quantity T=(×1+(×2−wideScale))*t corresponding to the magnification transition zone, wherein ×1 is a magnification corresponding to a first field of vision (FOV), ×2 is a magnification corresponding to a second FOV, wideScale is an actual magnification corresponding to the first camera under the current set magnification, and t is a translation quantity of the first scaled image aligned to the second scaled image under the current set magnification.

Optionally, as a feasible implementation, the first acquisition module 61 is also configured for setting a stereo correction matrix under the current set magnification as H_{wt}=Hₛ₂*H_{wt}*Hₛ₁, wherein H_{wt}=Kₜ*R_{tw}⁻¹*K_{w}⁻¹, representing a stereo correction matrix aligning a first original image to a second original image; Kₜ is a calibration internal parameter of the second camera; K_{w} is a calibration internal parameter of the first camera; R_{tw} is a pre-calibrated rotation matrix from the first camera to the second camera;

Hₛ₁ represents a magnification matrix converting the first scaled image to the first original image; and Hₛ₂ represents a magnification matrix converting the second original image to the second scaled image.

Optionally, as a feasible implementation, the first calculation module 63 is also configured for setting a translation matrix Hₜ as follows:

$${H}_{t} = [ \begin{matrix}1 & 0 & \frac{wideScale - first critical magnification}{\begin{matrix}second critical magnification - \\ first critical magnification\end{matrix}} ⋆ {T}_{x} - {T}_{0 x} \\ 0 & 1 & \frac{wideScale - first critical magnification}{\begin{matrix}second critical magnification - \\ first critical magnification\end{matrix}} ⋆ {T}_{y} - {T}_{0 y} \\ 0 & 0 & 1\end{matrix} ]$$

T₀ₓ is a quantity of translation completed from a first critical magnification to a current display magnification in an x-direction, and T_{0y} is a quantity of translation completed from the first critical magnification to the current display magnification in a y-direction; Tₓ is a total translation quantity from the current display magnification to a second critical magnification in the x-direction; and T_{y} is a total translation quantity from the current display magnification to the second critical magnification in the y-direction.

Optionally, as a feasible implementation, the second calculation module 64 is also configured for:

setting a smooth transition transformation matrix as H=Hₜ*Hₛ₃*H_{wt}Hₛ₁, wherein Hₜ is the translation matrix;

$${H}_{s 3} = {H}_{s 1}^{- 1} ⋆ [ \begin{matrix}fw / ft & 0 & 0 \\ 0 & fw / ft & 0 \\ 0 & 0 & 1\end{matrix} ] ;$$

Hₛ₁⁻¹ is a magnification matrix converting the first original image to the first scaled image; fw and ft are focal lengths of the first camera and the second camera under the same resolution, respectively; H_{wt} represents a stereo correction matrix aligning the first original image to the second original image; and Hₛ₁ represents a magnification matrix converting the first scaled image to the first original image.

The multi-camera zoom control apparatus provided by the example of the present application has the same implementation principle and generated technical effects as those of the foregoing method examples. For a brief description, portions not mentioned in the example of the multi-camera zoom control apparatus may be referred to the corresponding contents in the foregoing method examples.

On the basis of aforementioned embodiments, the present example also provides a computer-readable storage medium having a computer program stored thereon. The computer program, when executed by a processor, performs the steps of the aforementioned multi-camera zoom control method.

A computer program product for a multi-camera zoom control method and apparatus, and an electronic system provided by the embodiment of the present application includes a computer-readable storage medium storing a program code. The program code includes instructions operable to perform the method in the foregoing method examples. The computer program product may be specifically implemented with reference to the method examples, and detailed descriptions are omitted herein.

The functions, if implemented in the form of software functional units and sold or used as stand-alone products, may be stored in a computer-readable storage medium. Based on such an understanding, the technical solution of the present application, in essence or in part contributing to the related art or in part, may be embodied in the form of a software product. The computer software product is stored in a storage medium including a number of instructions for causing a computer device (which may be a personal computer, a server, or a network device, etc.) to perform all or part of the steps of the method according to various examples of the present application. The foregoing storage medium includes: a U disk, a mobile hard disk, a ROM, a RAM, a magnetic disk, or an optical disc, and other media which may store program codes.

Finally, it should be noted that the examples described above are merely specific embodiments of the present application for illustrating the technical solutions of the present application, rather than limiting the present application. The protection scope of the present application is not limited thereto. Although the present application has been described in detail with reference to the foregoing examples, a person ordinarily skilled in the art should appreciate that any person skilled in the art, within the technical scope of the present application, may still make modifications or readily think of changes to the technical solutions described in the foregoing examples, or make equivalent substitutions for some of the technical features therein. However, such modifications, changes or substitutions do not make the essence of the corresponding technical solutions depart from the spirit and scope of the technical solutions of the examples of the present application and are intended to be included within the protection scope of the present application. Therefore, the protection scope of the present application should be determined by the protection scope of the claims.

### INDUSTRY UTILITY

The multi-camera zoom control method and apparatus, and an electronic system and a storage medium, in the process of collecting an image by a first camera, if a current set magnification input by a user is in a magnification transition zone, a second camera is started. A stereo correction matrix under the current set magnification is acquired on the basis of calibration parameters of the first camera and the second camera. A translation matrix is calculated on the basis of an acquired pixel position corresponding relationship between the same content regions of interest that correspond to a first scaled image and a second scaled image and in combination with the current set magnification. A smooth transition transformation matrix corresponding to the magnification transition zone is calculated according to the stereo correction matrix and the translation matrix. Performing affine transformation to an image output by the first camera. According to the method, a stable translation quantity is obtained in a region of interest on the basis of stereo correction alignment of an image by using a template matching mode (determining a region of interest in a first scaled image, taking the region of interest as a template, and determining a target region corresponding to the template in a second scaled image, a pixel position corresponding relationship between the region of interest and the target region being a pixel position corresponding relationship between the same content regions of interest corresponding to the first scaled image and the second scaled image), so as to realize the smooth transition of the region of interest, thereby improving the alignment stability of the region of interest.

1. A multi-camera zoom control method, applied to a device configured with a first camera and a second camera, wherein the device is pre-configured with a magnification transition zone, the method comprises:
starting the second camera when a current set magnification input by a user is in the magnification transition zone in a process of collecting an image by the first camera.
acquiring a stereo correction matrix under the current set magnification on the basis of calibration parameters of the first camera and the second camera;
acquiring a first scaled image corresponding to the first camera and a second scaled image corresponding to the second camera;
calculating a translation matrix on the basis of a pixel position corresponding relationship between same content regions of interest that correspond to the first scaled image and the second scaled image and the current set magnification;
calculating a smooth transition transformation matrix corresponding to the magnification transition zone according to the stereo correction matrix and the translation matrix; and
performing affine transformation to an image output by the first camera by applying the smooth transition transformation matrix, to obtain a display image of the device.

2. The method according to claim 1, wherein the step of acquiring the first scaled image corresponding to the first camera and the second scaled image corresponding to the second camera comprises:
performing central cutting and zooming in to a first original image collected by the first camera to obtain a first scaled image; and
performing central cutting and zooming in to a second original image collected by the second camera to obtain a second scaled image.

3. The method according to claim 1, wherein the magnification transition zone is a corresponding magnification interval between a preset first critical magnification and a preset second critical magnification, and the second critical magnification is a corresponding magnification when the display image of the device is switched from an image collected by the first camera to an image collected by the second camera.

4. The method according to claim 3, wherein the first scaled image and the second scaled image have the same resolution;
the step of calculating a translation matrix on the basis of the pixel position corresponding relationship between the same content regions of interest that correspond to the first scaled image and the second scaled image and the current set magnification comprises:
determining a total translation quantity corresponding to the magnification transition zone on the basis of the pixel position corresponding relationship between the same content regions of interest that correspond to the first scaled image and the second scaled image; and
calculating a translation matrix according to the current set magnification and the total translation quantity.

5. The method according to claim 4, wherein the resolution corresponding to the first scaled image and the second scaled image is a resolution corresponding to the second critical magnification.

6. The method according to claim 4, wherein the step of determining the total translation quantity corresponding to the magnification transition zone on the basis of the pixel position corresponding relationship between the same content regions of interest that correspond to the first scaled image and the second scaled image comprises:
determining a focus point of the first scaled image;
determining a first region of interest of the first scaled image and a second region of interest of the second scaled image by taking the focus point as a center;
performing feature detection on the first region of interest and the second region of interest, to obtain first feature information corresponding to the first region of interest and second feature information corresponding to the second region of interest;
determining a translation quantity of the first scaled image aligned to the second scaled image under the current set magnification on the basis of a pixel position corresponding relationship corresponding to the same feature information in the first feature information and the second feature information; and
determining a total translation quantity corresponding to the magnification transition zone according to the translation quantity.

7. The method according to claim 6, wherein the step of determining the focus point of the first scaled image comprises:
detecting whether a target object is contained in the first scaled image;
taking a center of the target object as the focus point when the target object is contained in the first scaled image; and
taking a center of the first scaled image as the focus point when the target object is not contained in the first scaled image.

8. The method according to claim 6, wherein the step of determining the focus point of the first scaled image comprises:
when a display screen of the device is a touch screen, monitoring a point touch operation of a user on the touch screen; and
taking the monitored point touch operation position as the focus point of the first scaled image.

9. The method according to claim 6, wherein a graph of the second region of interest has the same shape as that of a graph of the first region of interest, and the graph of the second region of interest is larger than the graph of the first region of interest.

10. The method according to claim 6, wherein the step of determining the total translation quantity corresponding to the magnification transition zone according to the translation quantity comprises:
setting the total translation quantity T=(×1+(×2−wideScale))*t corresponding to the magnification transition zone, wherein ×1 is a magnification corresponding to a first field of vision (FOV), ×2 is a magnification corresponding to a second FOV, wideScale is an actual magnification corresponding to the first camera under the current set magnification, and t is a translation quantity of the first scaled image aligned to the second scaled image under the current set magnification.

11. The method according to claim 4, wherein the step of calculating the translation matrix according to the current set magnification and the total translation quantity comprises:
setting a translation matrix Hₜ as follows:
$${H}_{t} = [ \begin{matrix}1 & 0 & \frac{wideScale - first critical magnification}{\begin{matrix}second critical magnification - \\ first critical magnification\end{matrix}} ⋆ {T}_{x} - {T}_{0 x} \\ 0 & 1 & \frac{wideScale - first critical magnification}{\begin{matrix}second critical magnification - \\ first critical magnification\end{matrix}} ⋆ {T}_{y} - {T}_{0 y} \\ 0 & 0 & 1\end{matrix} ]$$
T₀ₓ, is a quantity of translation completed from the first critical magnification to a current display magnification in an x-direction, and Tₒ₀ is a quantity of translation completed from the first critical magnification to the current display magnification in a y-direction; Tₓ is a total translation quantity from the first critical magnification to the second critical magnification in the x-direction; and T_{y} is a total translation quantity from the first critical magnification to the second critical magnification in the y-direction.

12. The method according to claim 1, wherein the step of acquiring the stereo correction matrix under the current set magnification on the basis of the calibration parameters of the first camera and the second camera comprises:
setting the stereo correction matrix under the current set magnification as H_{w1}=Hₛ₂*H_{wt}*Hₛ₁, wherein H_{wt}=Kₜ*R_{wt}⁻¹*K_{w}⁻¹: H_{wt} represents the stereo correction matrix aligned from the first original image to the second original image; Kt is a calibration internal parameter of the second camera; K_{w} is a calibration internal parameter of the first camera; R_{wt} d is a pre-calibrated rotation matrix from the first camera to the second camera; Hₛ₁ represents a magnification matrix converting the first scaled image to the first original image; and Hₛ₂ represents a magnification matrix converting the second original image to the second scaled image.

13. The method according to claim 1, wherein the step of calculating the smooth transition transformation matrix corresponding to the magnification transition zone according to the stereo correction matrix and the translation matrix comprises:
setting the smooth transition transformation matrix as H=Hₜ*Hₛ₃*H_{wt}*Hₛ₁, wherein Hₜ is the translation matrix;
$${H}_{s 3} = {H}_{s 1}^{- 1} ⋆ [ \begin{matrix}fw / ft & 0 & 0 \\ 0 & fw / ft & 0 \\ 0 & 0 & 1\end{matrix} ] ;$$
Hₛ₁⁻¹ is a magnification matrix converting the first original image to the first scaled image; fw and ft are focal lengths of the first camera and the second camera under the same resolution, respectively; H_{wt} represents the stereo correction matrix aligned from the first original image to the second original image; and Hₛ₁ represents the magnification matrix converting the first scaled image to the first original image.

14. (canceled)

15. An electronic system, wherein the electronic system is a device configured with a first camera and a second camera, the device is pre-configured with a magnification transition zone;
the electronic system comprises an image input apparatus, a processor and a storage apparatus;
the image input apparatus is configured for acquiring image data collected by the first camera and second camera; and
the storage apparatus stores a computer program which, when executed by the processor, performs the operations comprising:
starting the second camera when a current set magnification input by a user is in the magnification transition zone in a process of collecting an image by the first camera.
acquiring a stereo correction matrix under the current set magnification on the basis of calibration parameters of the first camera and the second camera;
acquiring a first scaled image corresponding to the first camera and a second scaled image corresponding to the second camera;
calculating a translation matrix on the basis of a pixel position corresponding relationship between same content regions of interest that correspond to the first scaled image and the second scaled image and the current set magnification;
calculating a smooth transition transformation matrix corresponding to the magnification transition zone according to the stereo correction matrix and the translation matrix; and
performing affine transformation to an image output by the first camera by applying the smooth transition transformation matrix, to obtain a display image of the device.

16. A computer-readable storage medium having a computer program stored thereon, wherein the computer program, when executed by a processor, performs steps of a multi-camera zoom control method according to claim 1.

17. The electronic system according to claim 15, wherein the operation of acquiring the first scaled image corresponding to the first camera and the second scaled image corresponding to the second camera comprises:
performing central cutting and zooming in to a first original image collected by the first camera to obtain a first scaled image; and
performing central cutting and zooming in to a second original image collected by the second camera to obtain a second scaled image.

18. The electronic system according to claim 15, wherein the magnification transition zone is a corresponding magnification interval between a preset first critical magnification and a preset second critical magnification, and the second critical magnification is a corresponding magnification when the display image of the device is switched from an image collected by the first camera to an image collected by the second camera.

19. The electronic system according to claim 18, wherein the first scaled image and the second scaled image have the same resolution;
the operation of calculating a translation matrix on the basis of the pixel position corresponding relationship between the same content regions of interest that correspond to the first scaled image and the second scaled image and the current set magnification comprises:
determining a total translation quantity corresponding to the magnification transition zone on the basis of the pixel position corresponding relationship between the same content regions of interest that correspond to the first scaled image and the second scaled image; and
calculating a translation matrix according to the current set magnification and the total translation quantity.

20. The electronic system according to claim 19, wherein the resolution corresponding to the first scaled image and the second scaled image is a resolution corresponding to the second critical magnification.

21. The electronic system according to claim 19, wherein the operation of determining the total translation quantity corresponding to the magnification transition zone on the basis of the pixel position corresponding relationship between the same content regions of interest that correspond to the first scaled image and the second scaled image comprises:
determining a focus point of the first scaled image;
determining a first region of interest of the first scaled image and a second region of interest of the second scaled image by taking the focus point as a center;
performing feature detection on the first region of interest and the second region of interest, to obtain first feature information corresponding to the first region of interest and second feature information corresponding to the second region of interest;
determining a translation quantity of the first scaled image aligned to the second scaled image under the current set magnification on the basis of a pixel position corresponding relationship corresponding to the same feature information in the first feature information and the second feature information; and
determining a total translation quantity corresponding to the magnification transition zone according to the translation quantity.
